(19) United States
(12) Patent Application Publication
(10) Pub. No.: US 2008/0005254 A1
(43) Pub. Date: Jan. 3, 2008

(54) INSTANT MESSAGING REDIRECTION AND AUTHORITY CONFIRMATION

(75) Inventors: Jennifer L. Adolphs, Stewartville, MN (US); Zachary A. Garbow, Rochester, MN (US); Elizabeth B. Silberg, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/427,806

(22) Filed: Jun. 30, 2006

(51) Int. Cl. G06F 15/16

(52) U.S. Cl. 709/207

(57) ABSTRACT

Exemplary embodiments include a method for instant messaging including redirection and authority confirmation including: establishing a chat session between a first chat party and a second chat party; contacting an authority to monitor the chat between the first and second chat parties; monitoring the chat session between the first and second chat parties based upon a set of rules; and blocking a chat message from a first chat party responsive to the set of rules.

### TRADEMARK

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to the field of instant messaging. More specifically, the present invention relates to an instant messaging redirection and authority confirmation system.

2. Description of Background

Instant messaging (IM) is quickly becoming the most effective way of contacting someone for an immediate response. People are often relaxed and informal with instant messaging, and IMs allow for more personal communication than emails. Along with the efficiency of a real time, informal conversation, instant messaging allows for immediate and sometimes automatic storage of an entire conversation, which can create potentially problematic situations.

For example, a company employee is talking to an external customer or Independent Software Vendor, ISV, via IM about an upcoming product offering in which the employee has an invention disclosure pending review. The customer starts asking lots of questions about the details of product. The employee knows the answers, but is unsure if disclosing certain details will breach confidentiality issues, or jeopardize his/her patent opportunities.

In another example, an employee is discussing a project with an external customer and the customer asks about the dates for different cycles of test and release involved in the project. The employee remembers signing a Nondisclosure Agreement, but cannot remember the exact restrictions involved. Preserving intellectual property rights, keeping release dates within the company, and not settling on un-thought out decisions are important to every company. A company's or individual's image, reputation, and protection of IP are at stake. With instant messaging becoming ubiquitous, along with the relaxed feel of instant messaging, the preservation of intellectual property continues to get harder. Not only is it easier to let an idea ‘slip’ but also the exact wording of the idea can be saved and redistributed almost instantly.

Some currently available IM programs include a group chat option; however, the group chat does not address the problems discussed above. For example, a third party to a chat, such as a company's lawyer or coworker, can correct an employee during a group chat session, but this can occur only after the fact, and oftentimes the disclosure of information and subsequent damage has already been done.

### SUMMARY OF THE INVENTION

Exemplary embodiments include a method for instant messaging including redirection and authority confirmation including: establishing a chat session between a first chat party and a second chat party; contacting an authority to monitor the chat between the first and second chat parties; monitoring the chat session between the first and second chat parties based upon a set of rules; and blocking a chat message from a first chat party responsive to the set of rules.

Exemplary embodiments also include a method for instant messaging including redirection and authority confirmation including: receiving a request for a chat session with a second chat party from a first chat party; determining if an authority is required for the chat session based upon a set of rules; determining if the authority is available for the chat session; contacting the second chat party to request the chat session; establishing the chat session between the first chat party and the second chat party; and monitoring the chat party for a dangerous content based upon the set of rules.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which provides an instant messaging redirection and authority confirmation system.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a block diagram of an instant messaging redirection and authority confirmation system in accordance with exemplary embodiments; and

FIG. 2 illustrates a flow chart of a method for instant messaging including redirection and authority confirmation in accordance with exemplary embodiments.

The detailed description explains the preferred embodiments of the invention, together with advantages and features, by way of example with reference to the drawings.

### DETAILED DESCRIPTION OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

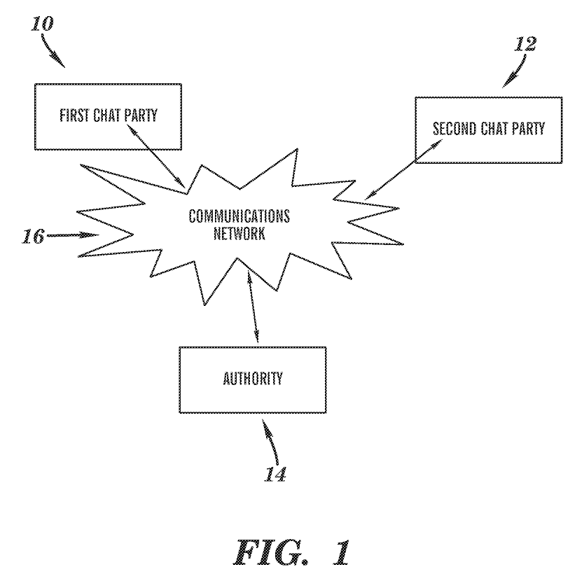

Referring now to FIG. 1, a block diagram of an instant messaging redirection and authority confirmation system. The system includes a first chat party 10, a second chat party 12, an authority 14, and a communications network 16. In one embodiment, the first chat party 10 and the second chat party 12 are communicating via an IM over the communications network 16. The authority 14 is able to monitor, edit, and comment on IM messages created by the first chat party 10 before they are sent to the second chat party 12. The review process by the authority 14 can be invisible to the second chat party 12. In one embodiment, the authority 14 is a legal representative, a team leader, an expert or simply multiple people communicating as a single voice.

In exemplary embodiments, rules can be defined for specific chats. For example, the rules may determine whether an authority is required or suggested for a specific chat session depending on the participants or subject matter of the chat. In addition, the rules may be used to determine which authorities are qualified to monitor the based on the chat content or participants. Further, the rules may require an authority to respond when certain keywords are used during the chat. Finally, the rules may also contain instructions for the situation where the ‘customer’ contacts the person requiring the authority, or employee, requesting a chat. In exemplary embodiments, the instant messaging authority provides real-time “proof reading” of IM communications similar to how many users have important email communications proof read for accuracy and legal purposes.

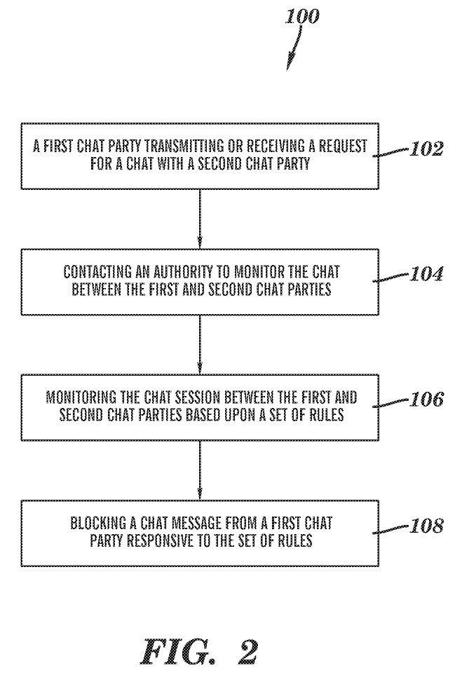

Referring now to FIG. 2, a flow chart of a method for instant messaging including redirection and authority confirmation in accordance with exemplary embodiments is generally illustrated as 100. The method 100 includes a first chat party transmitting or receiving a request for a chat with a second chat party, as shown at method step 102. In one embodiment, the first chat party can be one person or a group of people involved in the chat and the first chat party will always be the person enabled to use the authority. After transmitting or receiving a request for a chat with a second chat party the method 100 includes contacting an authority to monitor the chat between the first and second chat parties, as shown at method step 104. The second chat party may or may not be made aware of the presence of the authority. The method 100 also includes monitoring the chat session between the first and second chat parties based upon a set of rules, as shown at method step 106. At step 108, the method 100 includes blocking a chat message from a first chat party responsive to the set of rules.

In one exemplary embodiment, User A (for example, a company employee) is communicating via IM with User B (for example, a client representing another company) and wishes to filter his/her comments through an appropriate authority, which may be an expert in the field or a lawyer. The authority can monitor the chat and review or edit User A's comments before they are sent to User B. User B does not have knowledge of the authority's presence, as User A and the authority are acting as one voice representing the company. Optionally, User A can configure presentation options to allow User B knowledge of the authority's presence, which may be useful in certain intra-team communications.

In another exemplary embodiment, a first chat user who wishes to have his comments redirected through an authority and the second chat user is a chat recipient, who may reside in another company. The first chat user contacts the second chat user and creates a new chat requiring the presence of an authority. The first chat user may initiate the chat by dragging recipients into recipient section of chat window and dragging the appropriate authorities (or authority priority list) into authority section of chat window. The authority confirms initiation before the chat session is actually initiated with the second chat user. The required confirmation from the authority is based on preset rules for this specific authority chat, and in alternate embodiments, the chat can be initiated immediately while waiting for the authority to join.

In another exemplary embodiment a second chat user wishes to contact a first chat user to establish a chat session. The online status of the first chat user, as displayed to the second chat user, may be based on whether authorities on the authority priority list are available. The priority list is a list of appropriate authorities for a particular topic of customer chat. If all people on authority list are ‘away’, the first chat user is shown as ‘away’ for the people with whom he is requiring using authority chat.

In exemplary embodiments, a set of rules may be used to monitor chat sessions. For example, when a specific individual initiates a chat, the appropriate authority may be invited automatically. If an authority is not present for a chat, rules can be set up to trigger a reminder to invite an authority if enough keywords or phrases are used. The keywords or phrases are words considered ‘dangerous’ for a specific chat and can be set within a keyword rule in advance by first chat user. In exemplary embodiments, specific keywords can be set or a ‘standard keyword set’ can be selected (e.g., Legal keyword set includes pre-selected words like license, patent, etc). When the second chat user sends a keyword to the first chat user, the words can either get highlighted so first chat user is aware of the danger. Additionally, an authority may be automatically contacted upon the detection of a keyword or phrase.

A number of techniques can be used to redirect messages to the authority. In one example, all messages from the first chat user are redirected to the authority before being transmitted to the second chat user. In another example, the first chat user can manually redirect specific messages to the authority before they are transmitted to the second chat user. In yet another example, redirection can be determined automatically via keywords. Messages redirected to the authority can be simply monitored to ensure accuracy, or can be edited or modified before being transmitted to the second chat user. The authority can set a transmission buffer to automatically transmit the message if it is not blocked/paused within X seconds, which allows for the conversation to continue as normal even if the authority is busy for a moment or forgets to manually hit “transmit.” This also allows the authority to block or pause a message from being transmitted while he/she gives it thought or edits the wording before hitting transmit. Furthermore, this allows the authority to control his/her level of involvement and balance the redirection and chat flow appropriately. Optionally, authority edits can be sent back to the first chat user before final transmission to the second chat user.

With the various options of preset rules, authority chat can range from making a conversation very constricted to mostly at ease. The nature of the rules will depend on the risk-level of the given conversation. This flexibility makes authority chats viable for nearly any business use. Merely having an authority present removes some of the relaxed, naive nature of instant messaging and protects a company's assets and reputation more carefully.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for instant messaging including redirection and authority confirmation comprising:
establishing a chat session between a first chat party and a second chat party;
contacting an authority to monitor the chat between the first and second chat parties;
monitoring the chat session between the first and second chat parties based upon a set of rules; and
blocking a chat message from a first chat party responsive to the set of rules.

2. The method of claim 1, further comprising monitoring the chat session for a keyword.

3. The method of claim 2, wherein the authority is a lawyer.

4. The method of claim 3, wherein the set of rules includes a list of approved authorities.

5. The method of claim 4, wherein the set of rules includes a list of second chat parties that require the presence of the authority.

6. A method for instant messaging including redirection and authority confirmation comprising:
receiving a request for a chat session with a second chat party from a first chat party;
determining if an authority is required for the chat session based upon a set of rules, the set of rules including a keyword;
determining if the authority is available for the chat session;
contacting the second chat party to request the chat session;
indicating the first chat party is unavailable if the authority is required and the authority is unavailable;
establishing the chat session between the first chat party and the second chat party; and
monitoring the chat session for a dangerous content based upon the set of rules, wherein the set of rules identifies keywords, wherein if the keyword is present in the chat content, the authority is required to accept/reject the use of the keywords.

7. The method of claim 6, further comprising notifying the second chat party that the authority is monitoring the chat session.

8. The method of claim 7, wherein the authority is a lawyer.

9. The method of claim 8, wherein dangerous content is a trade secret.
